(19) United States
(12) Patent Application Publication
(10) Pub. No.: US 2005/0031309 A1
(43) Pub. Date: Feb. 10, 2005

(54) Read-only recording medium containing menu data and menu displaying method therefor

(76) Inventors: Byung Jin Kim, Bundang-gu (KR); Sung Wan Park, Jangan-gu (KR); Kang Soo Seo, Dongan-gu (KR); Soung Hyun Um, Dongan-gu (KR)

Correspondence Address: HARNESS, DICKEY & PIERCE, P.L.C., P.O. BOX 8910, RESTON, VA, 20195, US

(21) Appl. No.: 10/488,347

(22) PCT Filed: Jul. 4, 2003
(86) PCT No.: PCT/KR03/01317

(30) Foreign Application Priority Data
Jul. 4, 2002 (KR) 10-2002-0038735

(51) Int. Cl. H04N 5/781

(52) U.S. Cl. 386/95; 386/125

(57) ABSTRACT

The present invention relates to a method for managing menu data of data stream recorded on an optical disc such as a high-density read-only optical disc. A read-only recording medium including menu data in accordance with the present invention is characterized in that its menu data contains at least one menu page picture in which a menu item is included, wherein said menu data contains item differentiating information that is used to differentiate one menu item from another in a displayed menu page picture. Owing to such constructed menu data, a menu page is constructed very fast.

### TECHNICAL FIELD

The present invention relates to a read-only recording medium such as a high-density read-only optical disc containing menu data pictures.

The present invention further relates to a method for managing menu data of data streams recorded on the read-only recording medium.

### BACKGROUND ART

Recently, the standardization for new high-density rewritable optical discs capable of recording high-quality video and audio data for a long time is in rapid progress and new optical disc related products are expected to be commercially available on the market in the near future. The Blu-ray Disc Rewritable (BD-RW) is one of the new optical discs.

Shown in FIG. 1 is the file structure adopted by a BD-RW. The root directory contains at least one BDVR directory which contains files such as ‘info.bdvr’, ‘menu.tidx’, and ‘mark.tidx’, a PLAYLIST directory in which play list files (*.rpls for a real play list and *.vpls for a virtual play list) are stored, a CLIPINF directory in which clip information files (*.clpi) are stored, and a STREAM directory in which MPEG2-formatted A/V stream clip files (*.m2ts) corresponding to the clip information files are stored.

A disc device, which records and reproduces data to/from a disc medium such as a BD-RW, is ordinarily structured as FIG. 2. The simplified block diagram of the disc device includes an optical pickup 2 for writing/reading signal to/from a disc medium; a VDR system 3 for conducting suitable data processing operation and controlling data recording/reproducing; and an encoder 4 for encoding input signal to digital data.

The disc device structured as above, at a user's request, converts input data to record-formatted data and records in the form of a clip file (*.m2ts) onto a placed disc medium. Further, the disc device reads the recorded data in the clip file and restores it to original data at reproduction mode.

In addition, the VDR system 3 of the disc device displays a menu page, that allows a user to easily select a title, a chapter or a play item of recorded A/V streams that the user wants to be played back, onto an external connected displaying machine, such as a television. For displaying such a menu page, a BD-RW includes pre-recorded information of plurality of menu items that constitute menu pages. The menu items are JPEG-formatted thumbnail pictures, texts to explain menu items, and so forth.

Therefore, the VDR system 3 of the disc device has to construct and display a menu page by adequately combining the pre-recorded menu items necessary to a menu page. However, such a menu page constructing operation requires a complicated combining algorithm and might display a wrongly-combined menu page in case of system malfunction as well.

Meanwhile, the standardization for high-density read-only, optical discs such as a Blu-ray ROM (called BD-ROM), which is a Capacity-equivalence of a BD-RW, is under way. An effective menu data scheme for providing a menu page for user's convenient selection is still needed for such a read-only disc. However, if the menu data scheme adopted by a BD-RW is also used for a BD-ROM, the above-mentioned problems would arise. Therefore, an effective menu data scheme to solve the problems is being urgently demanded.

### DISCLOSURE OF INVENTION

It is an object of the present invention to provide a menu data managing method being able to construct very simply a menu page for a real-only optical disc such as a BD-ROM.

A read-only recording medium including menu data in accordance with the present invention is characterized in that its menu data contains at least one menu page picture in which a menu item is included, wherein said menu data contains display-state control information such as item differentiating information that is used to differentiate one menu item from another in a displayed menu page picture.

A menu displaying method for a read-only recording medium in accordance with the present invention is characterized in that it comprises the steps of: reading a menu page picture from the recording medium wherein the menu page picture including a plurality of menu items; and displaying a certain menu item differently from others in the menu page picture by using display-state control information such as item differentiating information of the menu item that is used to differentiate one menu item from another.

### BRIEF DESCRIPTION OF DRAWINGS

The accompanying drawings, which are included to provide a further understanding of the invention, illustrate the preferred embodiments of the invention, and together with the description, serve to explain the principles of the present invention. In the drawings:

FIG. 1 illustrates the file structure of a Blu-ray Disc Rewritable (BD-RW);

FIG. 2 is a simplified block diagram of a disc device being capable of recording/reproducing a disc recording medium;

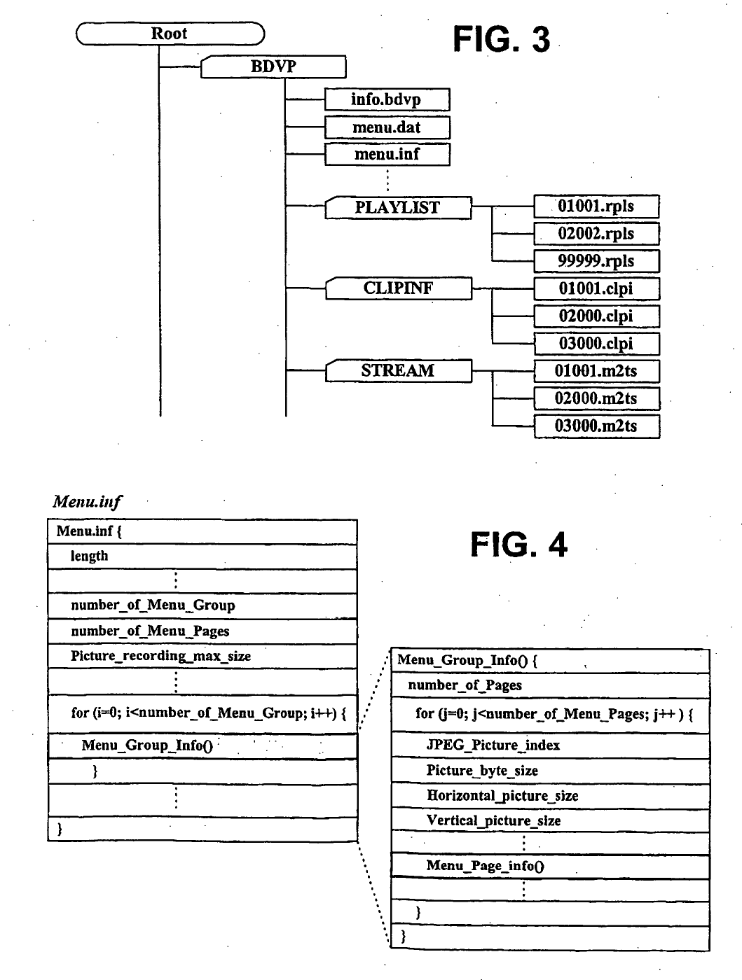

FIG. 3 illustrates the file structure of a high-density read-only optical disc in accordance with the invention;

FIGS. 4 to 6 are embodiments of menu data structure recorded by a menu data managing method in accordance with the present invention;

FIG. 7 is a simplified block diagram of a disc device to which a menu data managing method in accordance with the present invention is applied;

FIG. 8 illustrates a menu screen constructing process and menu screen switching conducted in accordance with the present invention; and

FIGS. 9A and 9B illustrate menu pages displayed by a menu data managing method in accordance with the present invention.

### MODES FOR CARRYING OUT THE INVENTION

In order that the invention may be fully understood, preferred embodiments there of will now be described with reference to the accompanying drawings.

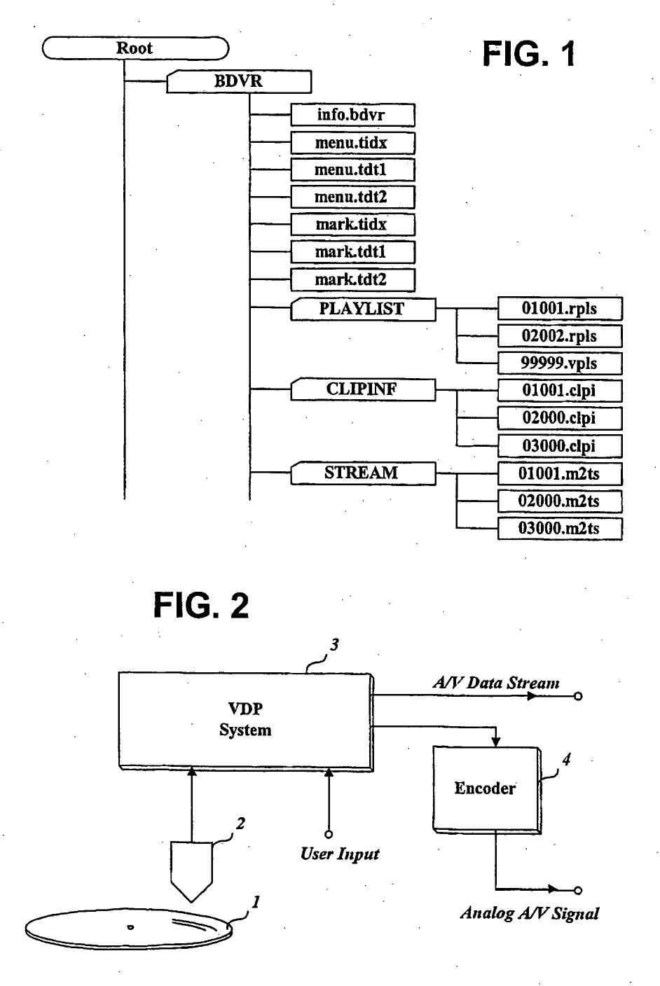

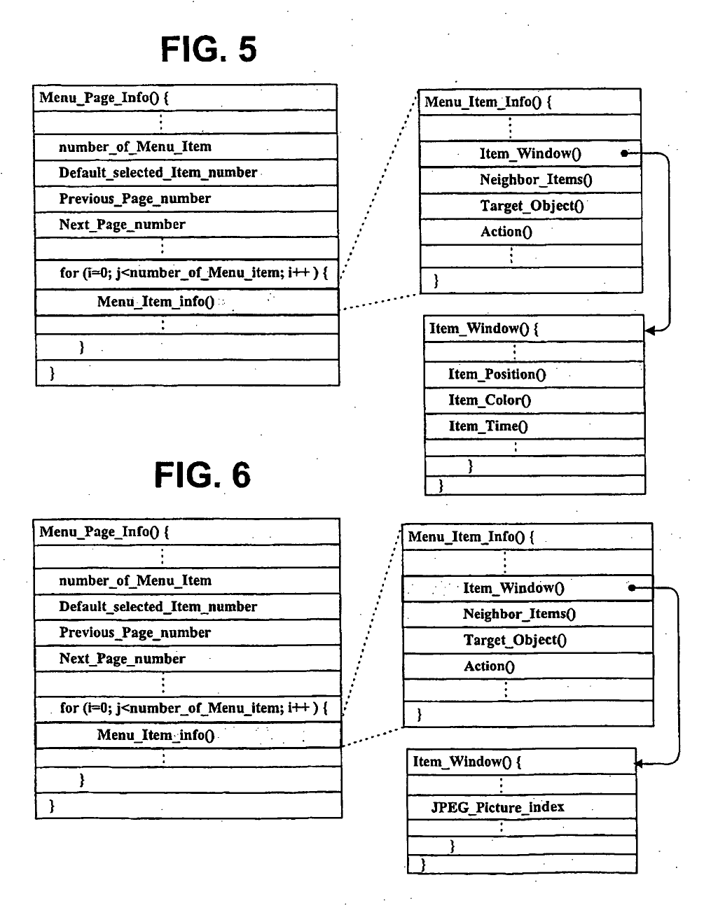

A high-density read-only optical disc, for example, a BD-ROM in accordance with the invention may have a file structure similar to the one mentioned above with reference to FIG. 1. For instance, the root directory contains at least one BDVP directory which contains files such as ‘info.bdvp’ and a PLAYLIST directory in which play list files (*.rpls and *.vpls) are stored, a CLIPINF directory in which clip information files (*.clpi) are stored, and a STREAM directory in which MPEG2-formatted A/V stream clip files (*.m2ts) corresponding to the clip information files are stored, as shown in FIG. 3.

And, the BD-ROM also contains menu data to allow a user to select more easily a title, a chapter or a playitem of A/V stream that the user wants.

The menu data is composed of many basic menu pages and their management information, and each of basic menu pages is a picture where a background image, menu title, thumbnails associated with titles or chapters of A/V stream sections, button images to switch a menu page or to move down/up to a child/parent menu page, texts to explain menu items or menu buttons, etc. are already combined.

In other words, a BD-ROM in accordance with the present invention includes not separate menu items but JPEG-encoded basic menu pictures where all necessary menu items have been already included.

Further, the menu data pre-recorded on a BD-ROM contains management information for highlighting a menu item, e.g., position information of each menu item within a menu page, when it is selected.

The basic menu pages of the menu data are recorded in the file ‘menu.dat’ while position information of each menu item and so on are recorded in the file ‘menu.inf’ as selected item display-state control information, e.g., display control information to highlight a selected item.

The JPEG-encoded menu pages can be grouped based on their mutual relations.

In below, a preferable embodiment of a menu data managing method in accordance with the present invention is described in detail.

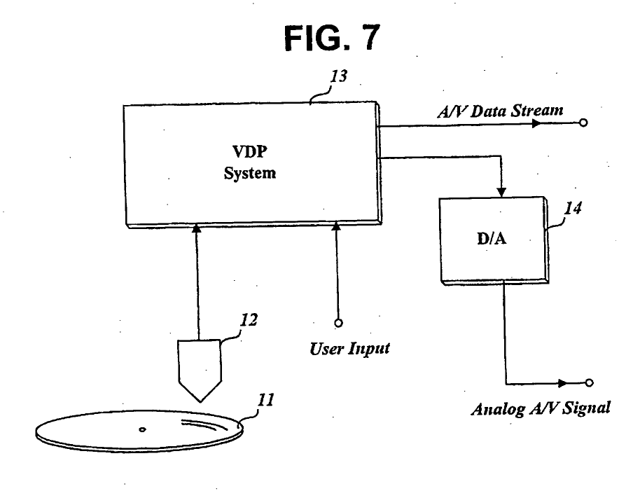

FIGS. 4 to 6 are embodiments of menu data structure recorded by a menu data managing method in accordance with the present. invention.

In case that JPEG-encoded basic menu pages (or menu pictures) recorded in the file ‘menu.dat’ are grouped by their mutual relations, group information of basic menu pages is recorded in the file ‘menu.inf’ structured as FIG. 4. The menu management information written in the file ‘menu.inf’ includes information about the number of groups ‘number_of_Menu_Group’, the number of basic menu pages ‘number_of_Menu_Page’, maximum size of JPEG menu picture ‘Picture_recording_max_size’, and so on.

Furthermore, the menu management information written in the file ‘menu.inf’ includes menu group information ‘Menu_Group_info’ containing detailed information for individual menu groups. The menu group information ‘Menu_Group_Info’ includes the number of menu pages pertaining to a menu group, index information ‘JPEG_Picture_index’ pointing to each menu page, data size ‘Picture_byte_size’ of actual picture data of each menu page, horizontal ‘Horizontal_picture_size’ and vertical length ‘Vertical_picture_size’ of each menu page, and so forth.

In addition, the menu group information ‘Menu_Group_Info’ includes menu page information ‘Menu_Page_Info’ containing detailed information for individual basic menu pages. The menu page information ‘Menu_Page_Info’ for each menu page, as shown in FIG. 5, includes the number of menu items ‘number_of_Menu_Item’, an item number ‘Default_selected_Item_number’ of a menu item to be selected in default at initial display, previous ‘Previous_Page_number’ and next menu page number ‘Next_Page_number’, and so on. If there is no a previous or a next page linked to a certain menu page, a previous or a next page number field of that menu page is written with a fixed value, e.g., ‘FFh’.

Each menu page information further includes menu item information ‘Menu_Item_Info’ containing detailed information for individual menu items included therein. The menu item information ‘Menu_Item_Info’ for each menu item, as shown in FIG. 5, includes display-state control information named item window information ‘Item_window’ containing item position information, etc. for highlighting related menu item, neighboring item information ‘Neighbor_Items’, information ‘Target_Object’ of a target object, e.g., title, chapter, and the like associated with a menu item, and action information how to process when a related menu item is executed.

Besides item position information, the item window information ‘Item_window’, which is information to make an item selected by a user distinguished from others, includes color information ‘Item_Color’ for differentiating a menu item from others, time information ‘Item_Time’ for holding or blinking highlighted state, etc. or determining user's request of execution automatically, as shown in FIG. 5.

In the embodiment of menu data illustrated in FIG. 5, information to distinguish a selected item from others is contained in the item window information ‘Item_window’.

However, menu data can be structured differently such that a menu item pre-encoded in highlight is to be placed in a basic menu page. FIG. 6 illustrates menu data structure for such an embodiment. The item window information ‘Item_window’ of menu item information given in FIG. 6 includes a picture index ‘JPEG_Picture_Index’ to point to a JPEG-encoded picture of a menu item that has been encoded in highlighted image. The highlighted menu item picture data may be recorded in the file ‘menu.dat’.

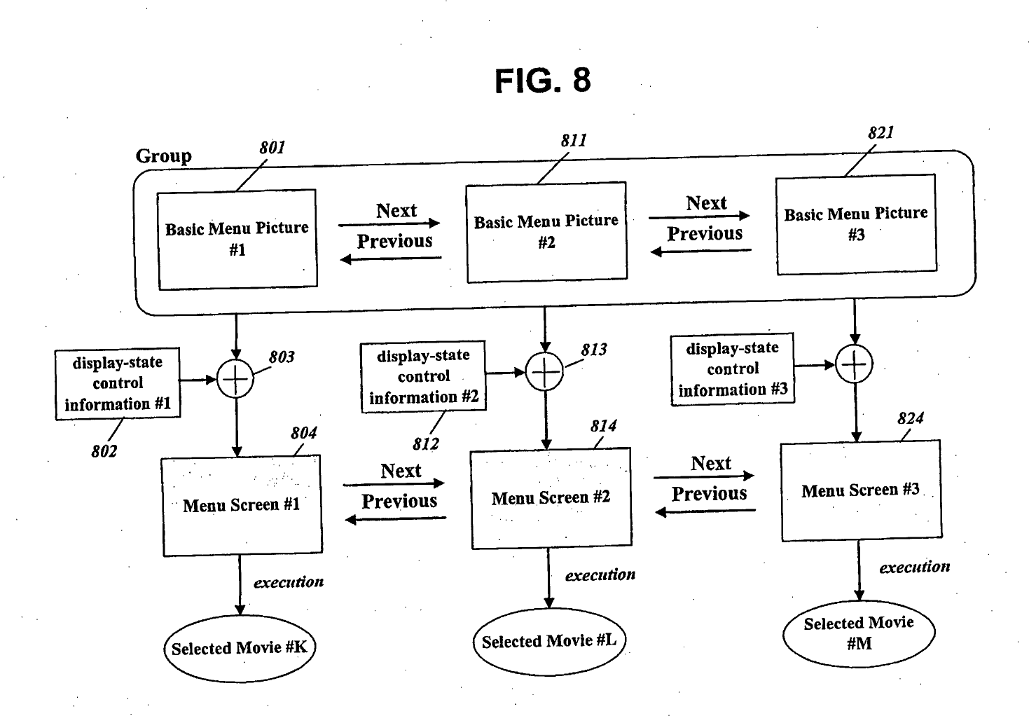

FIG. 7 is a simplified block diagram of a disc device for reproducing data written on a BD-ROM 11 that contains menu data structured as above.

The disc device of FIG. 7 includes an optical pickup 12 for reading signal recorded on a disc medium; a VOP system 13 for processing the read signal to restore to data and controlling data reproducing; and a D/A converter 14 for converting the restored data to an analog signal.

When the BD-ROM 11 is placed, the disc device conducts menu page displaying operation for convenient user's selection of a recorded clip file (*.m2ts) of A/V stream section.

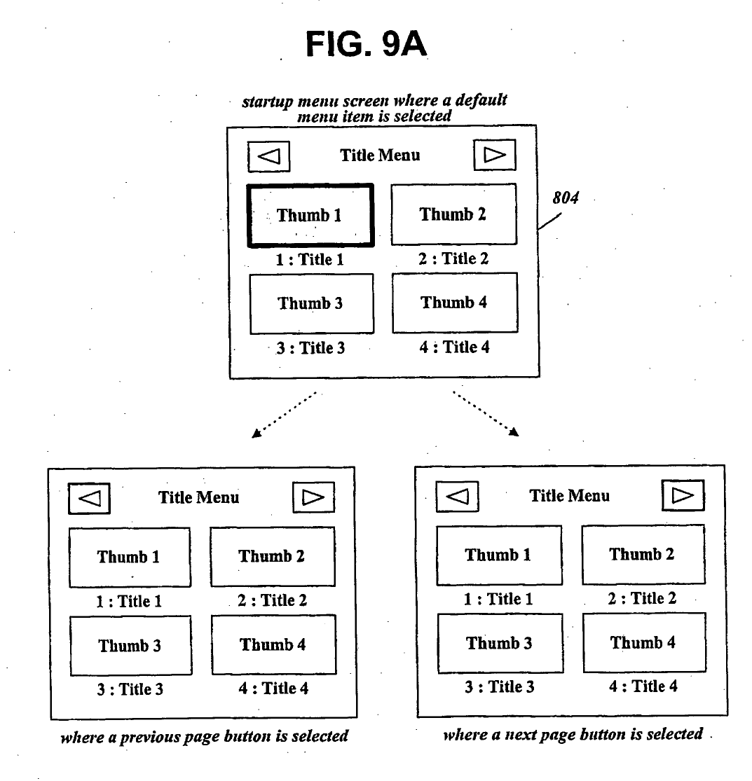

FIG. 8 illustrates a menu screen outputting process in accordance with the present invention.

For conducting a menu screen as illustrated in FIG. 8, the VDP system 13 examines the menu group information ‘Menu_Group_Info’ and the menu page information ‘Men_Page_Info’ written in the file ‘menu.inf’ to determine a startup menu page, namely, a menu page referred by the first menu page information in the first menu group information. If the startup menu page is determined, the VDP system 13 reads a corresponding basic menu page picture 801 written in the file ‘menu.dat’. Then, the VDP system 13 chooses a default menu item in the startup menu page by referring to the number information ‘Default_selected_Item_number’ in the menu page information ‘Menu_Page_Info’ associated with the determined startup menu page, checks the item window information ‘Item_Window’ 802, which is selected-state display control information, in the menu item information ‘Menu_Item_Info’ associated with the chosen menu item, and outputs a menu screen 804 made from the read basic menu picture to an external displaying machine such as a television after differentiating (803) the chosen menu item from others in the read basic menu picture with reference to the information written in the item window information. In outputting operation, necessary JPEG decoding is conducted by the VDP system 13. And, for the above item differentiation, a highlighting box surrounding the chosen menu item is added or the color of the chosen menu item is changed to be differentiated.

The highlighted menu item can be blinked at an interval given in the time information ‘Item_Time’

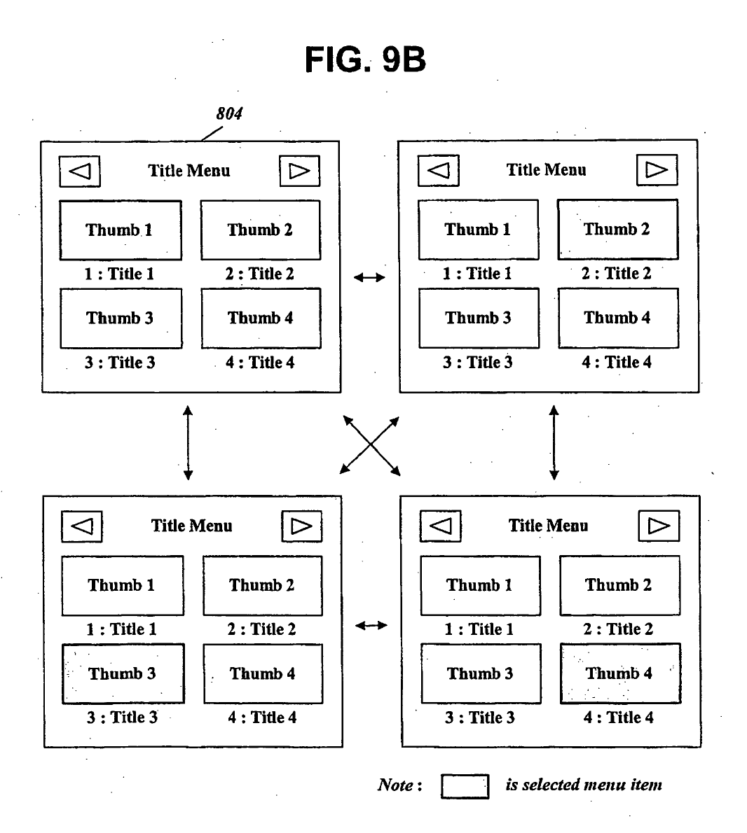

FIG. 9A illustrates a displayed startup menu screen 804 made by the above operations.

The menu page illustrated in FIG. 9A includes a menu title, four thumbnail pictures linked to four titles, and two buttons to switch to previous and next one, respectively.

In case that the menu data is structured as the embodiment of FIG. 6, instead of differentiating the chosen menu item as above, the VDP system 13 reads already-highlighted JPEG-encoded item picture by referring to item picture indexing information ‘JPEG_Picture_index’ included in the item window information of the chosen menu item, and overwrites a corresponding area within the read basic menu picture with the read already-highlighted item picture or inserts the read item picture into the basic menu picture before outputting the read basic menu page.

In the state that the menu page has been outputted, the VDP system 13 conducts tracking operation of user's movement of an input pointer or cursor keys. If it is determined based on the tracking information that a menu item other than the current highlighted one is selected, the VDP system 13 differentiates the moved menu item from others based on menu item information of the moved item the same as explained before.

FIG. 9A illustrates a case that previous/next page button is selected from the default menu item, namely, the first title-related thumbnail, and FIG. 9B illustrates respective menu pages where title-related thumbnails are selected individually.

If a user presses ‘Enter’ key on a selected menu item, the VDP system 13 executes an operation specified by the action field ‘Action’ included the menu item information of the selected menu item. That is, the VDP system 13 reproduces a related title if the action field ‘Action’ defines ‘reproduction’, or displays previous or next menu page picture if the action field defines ‘menu display’.

Switching among multiple menu pages is illustrated in FIG. 8. If a next button is executed at user's request in the event that the first basic menu picture 801 is outputted, the VDP system 13 reads out the next, namely, the second basic menu page picture 811 pertaining to the same group from the file ‘menu.dat’ and display-state control information 812 for a default-defined menu item in that page from the file ‘menu.inf’. After displaying (813) the default-defined menu item based on the display-state control information to differentiate from other items, the VDP system 13 outputs the thusly-constructed menu screen 814 to an external displaying machine as a next menu.

If a pervious or a next button on the second menu page picture 811 is executed, the previous 804 or the next menu screen 824 is constructed from the previous 801 or the next basic menu page picture 821 the same as explained before, and then outputted for a user selection.

In case that the time information ‘Item_Time’ in the item window information ‘Item_Window’ defines automatic execution time, if a selection lasting time of a certain menu item exceeds the given time in the time information ‘Item_Time’, the VDP system 13 regards without user's enter key that execution of the selected menu item is requested, and executes an operation defined by the action field ‘Action’.

In the above-explained embodiments, JPEG-encoded menu data pictures are concentrated in the single file ‘menu.dat’. However, menu data pictures can be written dividedly in several files. For example, in the event that a plurality of titles are recorded on a BD-ROM, menu data pictures associated all titles are written a file ‘Dmenu.dat’ under the directory ‘BDVP’ below the root while menu data pictures related with objects such as chapters within each title are written in each file ‘Tmenu.dat’ under additionally-created directory ‘TITLE’ below the directory ‘BDVP’.

The files ‘Dmenu.dat’ and ‘Tmenu.dat’ can be placed under same directory, e.g., ‘BDVP’ or newly-created directory ‘MENU’ under the directory ‘BDVP’.

The above-explained menu data managing method for a high-density read-only disc medium such as a BD-ROM can construct a menu page very fast for data streams recorded on a read-only disc medium, and never construct wrong menu pages including unrelated menu items that could be made from malfunction in conventional menu page constructing operation.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

1. A read-only recording medium, including menu data for data stream recorded thereon, wherein said menu data contains at least one menu page picture in which a menu item is included, and wherein said menu data contains display-state control information of the menu item.

2. The recording medium of claim 1, wherein said display-state control information is information that is used to display one menu item differently from others in a menu page picture.

3. The recording medium of claim 1, wherein said menu data contains grouping information to divide menu pages into several menu groups.

4. The recording medium of claim 1, wherein said menu item is a thumbnail related to a title of the data stream, an image of button to switch to other menu page picture, or a text of menu page title.

5. The recording medium of claim 1, wherein said at least one menu page picture is written in a single file.

6. The recording medium of claim 1, wherein said at least one menu page picture is written dividedly in several files.

7. The recording medium of claim 1, wherein said display-state control information includes position information of a menu item and color information of a menu item to differentiate from other items.

8. The recording medium of claim 1, wherein said display-state control information is an item image that has been made in highlighted state.

9. The recording medium of claim 1, wherein said menu data includes a threshold time to execute automatically a menu item in selected state, a highlighted state-holding time of a menu item, or an interval to blink a selected menu item periodically.

10. The recording medium of claim 1, wherein said menu data includes information about the number of groups and the number of menu page pictures, maximum size of a menu picture, and information of each group.

11. The recording medium of claim 10, wherein said information of each group includes the number of menu pages pertaining to a menu group, index information pointing to each menu page picture, data size of actual picture data of each menu page picture, horizontal and vertical length of each menu page picture, and information of each menu page.

12. The recording medium of claim 11, wherein said information of each menu page includes the number of included menu items, an item number of a menu item selected in default at initial display, previous and next menu page number, and information of each menu item.

13. The recording medium of claim 12, wherein said information of each menu item includes information for highlighting a related menu item, neighboring item information, information of a target object associated with a menu item, and action information how to process when a related menu item is executed.

14. The recording medium of claim 1, wherein said menu page picture is a JPEG-encoded picture.

15. A menu displaying method for a recording medium, comprising the steps of:
(a) reading a menu page picture from the recording medium, menu page picture including a plurality of menu items; and
(b) setting display-state of a certain menu item in the menu page picture based on display-state control information of the menu item and outputting the menu page picture including the display-state set menu item.

16. The method of claim 15, wherein said menu item is a thumbnail related to a title of the data stream recorded on the recording medium, an image of button to switch to other menu page picture, or a text of menu page title.

17. The method of claim 15, wherein said display-state control information is information that is used to display one menu item differently from others in the menu page picture.

18. The method of claim 17, wherein said differently displaying information includes position information of a menu item and color information of a menu item to differentiate from other items.

19. The method of claim 17, wherein said differently displaying information is an item image that has been made in highlighted state.

20. The method of claim 17, wherein said menu item is a menu item selected in default or by a user.

21. The method of claim 20, further comprising the step of executing a predefined operation for an arbitrary menu item if selection lasting time of the menu item exceeds a predetermined threshold time.

22. The method of claim 21, wherein said predefined operation is to display another menu page picture or to reproduce a data object associated with a menu item.
